(19) United States
(12) Patent Application Publication
(10) Pub. No.: US 2022/0237475 A1
(43) Pub. Date: Jul. 28, 2022

(54) CREATION METHOD, STORAGE MEDIUM, AND INFORMATION PROCESSING DEVICE

(71) Applicant: FUJITSU LIMITED, Kawasaki-shi (JP)

(72) Inventors: Kenichi KOBAYASHI, Kawasaki (JP); Yoshihiro OKAWA, Yokohama (JP); Yasuto YOKOTA, Kawasaki (JP); Katsuhito NAKAZAWA, Urawa (JP)

(73) Assignee: FUJITSU LIMITED, Kawasaki-shi (JP)

(21) Appl. No.: 17/719,453

(22) Filed: Apr. 13, 2022

Related U.S. Application Data
(63) Continuation of application No. PCT/JP2019/041806, filed on Oct. 24, 2019.

(51) Int. Cl. G06N 5/02

(52) U.S. Cl. CPC G06N 5/022

(57) ABSTRACT

A creation method that is executed by a computer, the creation method includes acquiring scores representing accuracy of classification of a machine learning model that classifies input data into classes; acquiring a difference in the scores between a first class that has a highest score and a second class that has a next highest score after the first class; and generating a first detection model that determines the classification is undecided when the difference is equal to or less than a first threshold value.

### CROSS-REFERENCE TO RELATED APPLICATION

This application is a continuation application of International Application PCT/JP2019/041806 filed on Oct. 24, 2019 and designated the U.S., the entire contents of which are incorporated herein by reference.

### FIELD

The embodiments discussed herein are related to a creation method, a storage medium, and an information processing device.

### BACKGROUND

In recent years, the introduction of machine learning models having data determination function and classification function and the like into information systems used by companies and the like has been progressing. Hereinafter, the information system will be referred to as “system”. Since the machine learning model makes determinations and classifications in line with teacher data learned at the time of system development, when the tendency of input data changes due to concept drift such as shifts of business judgment criteria during system operation, the accuracy of the machine learning model deteriorates.

FIG. 17 is a diagram for explaining the deterioration of the machine learning model due to changes in the tendency of the input data. The machine learning model described here is a model that classifies the input data into one of a first class, a second class, and a third class and is assumed to have learned in advance based on the teacher data before the system operation. The teacher data includes training data and validation data.

In FIG. 17, a distribution 1A illustrates a distribution of the input data at the initial stage of system operation. A distribution 1B illustrates a distribution of the input data at the time point when T1 hours have passed since the initial stage of system operation. Furthermore, a distribution IC illustrates a distribution of the input data at the time point when T2 hours have passed since the initial stage of system operation. It is assumed that the tendency (the feature amount and the like) of the input data changes with the passage of time. For example, if the input data is an image, the tendency of the input data changes depending on seasons and given times even for images in which the same subject is captured.

A decision boundary 3 indicates the boundary between model application areas 3a to 3c. For example, the model application area 3a is an area in which training data belonging to the first class is distributed. The model application area 3b is an area in which training data belonging to the second class is distributed. The model application area 3c is an area in which training data belonging to the third class is distributed.

The star marks represent the input data belonging to the first class, for which it is correct to be classified into the model application area 3a when input to the machine learning model. The triangle marks represent the input data belonging to the second class, for which it is correct to be classified into the model application area 3b when input to the machine learning model. The circle marks represent the input data belonging to the third class, for which it is correct to be classified into the model application area 3c when input to the machine learning model.

In the distribution 1A, all pieces of the input data are distributed in the normal model application areas. For example, the input data of the star marks is located in the model application area 3a, the input data of the triangle marks is located in the model application area 3b, and the input data of the circle marks is located in the model application area 3c.

In the distribution 1B, since the tendency of the input data has changed due to the concept drift, all pieces of the input data is distributed in the normal model application areas, but the distribution of the input data of the star marks has changed in the direction of the model application area 3b.

In the distribution IC, the tendency of the input data has further changed, and some pieces of the input data of the star marks have moved across the decision boundary 3 to the model application area 3b and are not properly classified, which lowers the correct answer rate (deteriorates the accuracy of the machine learning model).

Here, as a technique for detecting the accuracy deterioration of the machine learning model during operation, there is a prior technique using T2 statistic (Hotelling's T-square). In this prior technique, principal component analysis is conducted on the input data and the data group of the normal data (training data), and the T2 statistic of the input data is calculated. The T2 statistic is obtained by summing up the squares of the distances from the origin to the data of each standardized principal component. The prior technique detects the accuracy deterioration of the machine learning model on the basis of a change in the distribution of the T2 statistic of the input data group. For example, the T2 statistic of the input data group corresponds to the percentage of outlier data.

A. Shabbak and H. Midi, “An Improvement of the Hotelling T² Statistic in Monitoring Multivariate Quality Characteristics”, Mathematical Problems in Engineering, 1-15, 2012 is disclosed as related art.

### SUMMARY

According to an aspect of the embodiments, a creation method that is executed by a computer, the creation method includes acquiring scores representing accuracy of classification of a machine learning model that classifies input data into classes; acquiring a difference in the scores between a first class that has a highest score and a second class that has a next highest score after the first class; and generating a first detection model that determines the classification is undecided when the difference is equal to or less than a first threshold value.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is an explanatory diagram for explaining a reference technique;

FIG. 2 is an explanatory diagram for explaining a mechanism of detecting the accuracy deterioration of a machine learning model targeted for monitoring;

FIG. 3 is a diagram (1) illustrating an example of model application areas by the reference technique;

FIG. 4 is a diagram (2) illustrating an example of model application areas by the reference technique;

FIG. 5 is an explanatory diagram for explaining an outline of a detection model in the present embodiment;

FIG. 6 is a block diagram illustrating a functional configuration example of an information processing device according to the present embodiment;

FIG. 7 is an explanatory diagram illustrating an example of the data structure of a training data set;

FIG. 8 is an explanatory diagram for explaining an example of a machine learning model;

FIG. 9 is an explanatory diagram illustrating an example of the data structure of an inspector table;

FIG. 10 is a flowchart illustrating a working example of the information processing device according to the present embodiment;

FIG. 11 is an explanatory diagram explaining an outline of a process of selecting parameters;

FIG. 12 is an explanatory diagram illustrating an example of class classification of each model with respect to instances;

FIG. 13 is an explanatory diagram for explaining a sureness function;

FIG. 14 is an explanatory diagram explaining a relationship between an unknown area and the parameters;

FIG. 15 is an explanatory diagram explaining validation results;

FIG. 16 is a block diagram illustrating an example of a computer that executes a creation program; and

FIG. 17 is a diagram for explaining the deterioration of the machine learning model due to changes in the tendency of input data.

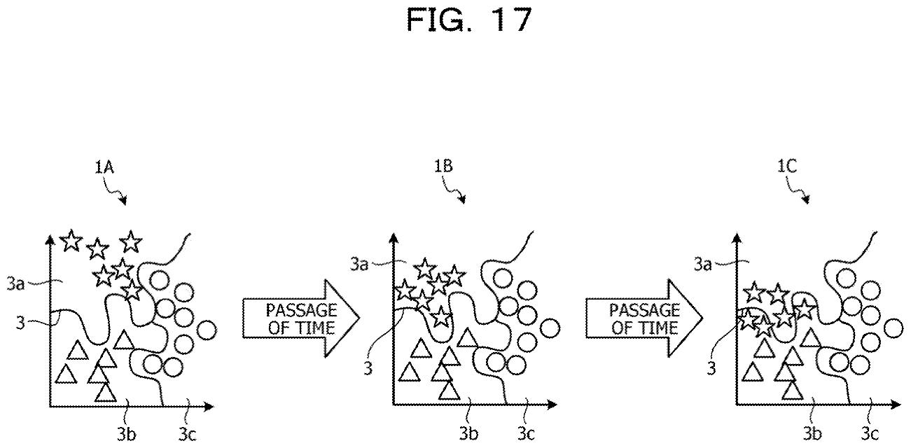

### DESCRIPTION OF EMBODIMENTS

The above prior technique uses a change in the distribution of the T2 statistic of the input data group as a basis and has a disadvantage that it is difficult to detect the accuracy deterioration of the machine learning model unless the input data is collected to some extent, for example.

In one aspect, it is aimed to provide a creation method, a creation program, and an information processing device capable of detecting the accuracy deterioration of a machine learning model.

Hereinafter, a creation method, a creation program, and an information processing device according to embodiments will be described with reference to the drawings. Constituents having the same functions in the embodiments are denoted with the same reference signs, and redundant description will be omitted. Note that the creation method, the creation program, and the information processing device described in the following embodiments are merely examples and do not limit the embodiments. Furthermore, each of the embodiments below may also be appropriately combined unless otherwise contradicted.

Before explaining the present embodiments, a reference technique for detecting the accuracy deterioration of a machine learning model will be described. In the reference technique, the accuracy deterioration of the machine learning model is detected using a plurality of monitoring tools for which model application areas are narrowed under different conditions. In the following description, the monitoring tools are referred to as “inspector models”.

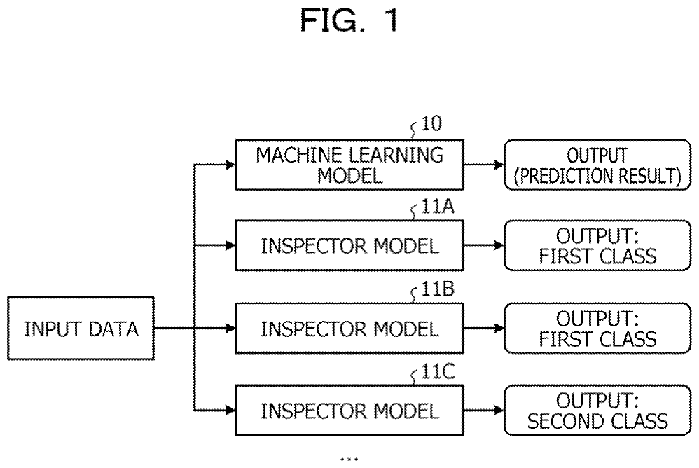

FIG. 1 is an explanatory diagram for describing the reference technique. A machine learning model 10 is a machine learning model that has conducted machine learning using teacher data. In the reference technique, the accuracy deterioration of the machine learning model 10 is to be detected. For example, the teacher data includes training data and validation data. The training data is configured to be used when parameters of the machine learning model 10 are machine-learned and is associated with correct answer labels. The validation data is data used when the machine learning model 10 is validated.

Inspector models 11A, 11B, and 11C are provided with model application areas narrowed under conditions different from each other and have different decision boundaries. Since the inspector models 11A to 11C have decision boundaries different from each other, the output results differ in some cases even if the same input data is input. In the reference technique, the accuracy deterioration of the machine learning model 10 is detected on the basis of variations in the output results of the inspector models 11A to 11C. The example illustrated in FIG. 1 illustrates the inspector models 11A to 11C, but the accuracy deterioration may also be detected using another inspector model. Deep neural networks (DNNs) are used for the inspector models 11A to 11C.

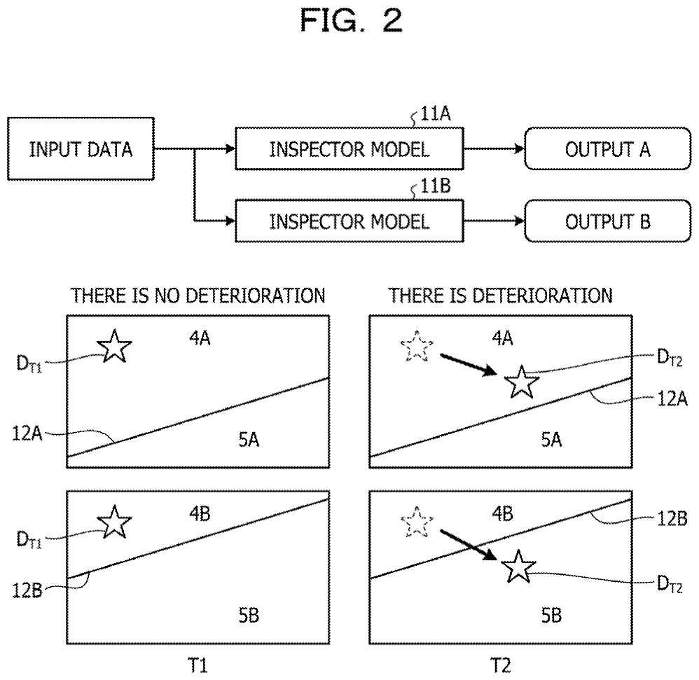

FIG. 2 is an explanatory diagram for explaining a mechanism of detecting the accuracy deterioration of the machine learning model targeted for monitoring. In FIG. 2, the inspector models 11A and 11B will be used for explanation. The decision boundary of the inspector model 11A is assumed as a decision boundary 12A, and the decision boundary of the inspector model 11B is assumed as a decision boundary 12B. The positions of the decision boundary 12A and the decision boundary 12B are different from each other, which gives different model application areas relating to class classification.

When the input data is located in a model application area 4A, the input data is classified into the first class by the inspector model 11A. When the input data is located in a model application area 5A, the input data is classified into the second class by the inspector model 11A.

When the input data is located in a model application area 4B, the input data is classified into the first class by the inspector model 11B. When the input data is located in a model application area 5B, the input data is classified into the second class by the inspector model 11B.

For example, when input data D_{T1} is input to the inspector model 11A at a time T1 in the initial stage of operation, the input data D_{T1} is classified into the “first class” because the input data D_{T1} is located in the model application area 4A. When input data D_{T1} is input to the inspector model 11B, the input data D_{T1} is classified into the “first class” because the input data D_{T1} is located in the model application area 4B. Since the classification results when the input data D_{T1} is input are the same between the inspector model 11A and the inspector model 11B, it is determined that “there is no deterioration”.

At a time T2 when some time has passed since the initial stage of operation, the tendency of the input data changes and becomes input data D_{T2}. When the input data D_{T2} is input to the inspector model 11A, the input data D_{T2} is classified into the “first class” because the input data D_{T2} is located in the model application area 4A. On the other hand, when the input data D_{T2} is input to the inspector model 11B, the input data D_{T2} is classified into the “second class” because the input data D_{T2} is located in the model application area 5B. Since the classification results when the input data D_{T2} is input are different between the inspector model 11A and the inspector model 11B, it is determined that “there is deterioration”.

Here, in the reference technique, when inspector models for which the model application areas are narrowed under different conditions are created, the number of pieces of the training data is reduced. For example, the reference technique randomly reduces the training data for each inspector model. In addition, in the reference technique, the number of pieces of the training data to be reduced is adapted for each inspector model.

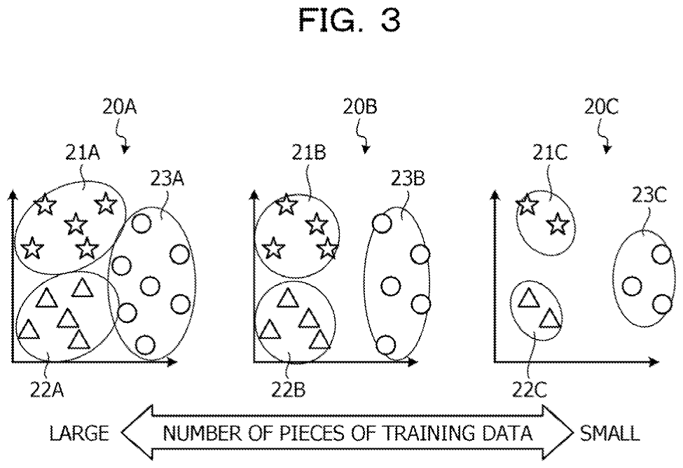

FIG. 3 is a diagram (1) illustrating an example of the model application areas by the reference technique. In the example illustrated in FIG. 3, distributions 20A, 20B, and 20C of the training data in a feature space are illustrated. The distribution 20A is a distribution of training data used when the inspector model 11A is created. The distribution 20B is a distribution of training data used when the inspector model 11B is created. The distribution 20C is a distribution of training data used when the inspector model 11C is created.

The star marks represent training data whose correct answer labels are given the first class. The triangle marks represent training data whose correct answer labels are given the second class. The circle marks represent training data whose correct answer labels are given the third class.

The number of pieces of the training data used when each inspector model is created is in the order of the inspector model 11A, the inspector model 11B, and the inspector model 11C in descending order of the number.

In the distribution 20A, the model application area for the first class is a model application area 21A. The model application area for the second class is a model application area 22A. The model application area for the third class is a model application area 23A.

In the distribution 20B, the model application area for the first class is a model application area 21B. The model application area for the second class is a model application area 22B. The model application area for the third class is a model application area 23B.

In the distribution 20C, the model application area for the first class is a model application area 21C. The model application area for the second class is a model application area 22C. The model application area for the third class is a model application area 23C.

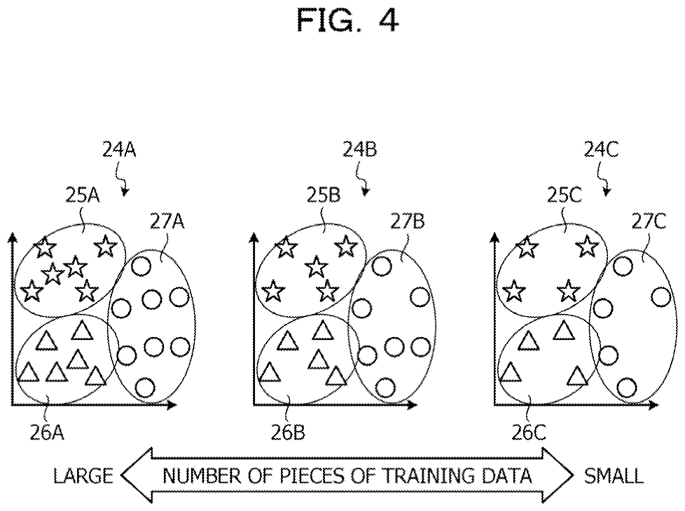

However, even if the number of pieces of the training data is reduced, the model application area is not necessarily narrowed in some cases as explained in FIG. 3. FIG. 4 is a diagram (2) illustrating an example of the model application areas by the reference technique. In the example illustrated in FIG. 4, distributions 24A, 24B, and 24C of the training data in a feature space are illustrated. The distribution 24A is a distribution of training data used when the inspector model 11A is created. The distribution 24B is a distribution of training data used when the inspector model 11B is created. The distribution 24C is a distribution of training data used when the inspector model 11C is created. The explanation of the training data of the star marks, triangle marks, and circle marks is similar to the explanation given in FIG. 3.

The number of pieces of the training data used when each inspector model is created is in the order of the inspector model 11A, the inspector model 11B, and the inspector model 11C in descending order of the number.

In the distribution 24A, the model application area for the first class is a model application area 25A. The model application area for the second class is a model application area 26A. The model application area for the third class is a model application area 27A.

In the distribution 24B, the model application area for the first class is a model application area 25B. The model application area for the second class is a model application area 26B. The model application area for the third class is a model application area 27B.

In the distribution 24C, the model application area for the first class is a model application area 25C. The model application area for the second class is a model application area 26C. The model application area for the third class is a model application area 27C.

As described above, in the example described in FIG. 3, each model application area is narrowed according to the number of pieces of the training data, but in the example described in FIG. 4, each model application area is not narrowed regardless of the number of pieces of the training data.

In the reference technique, it is difficult to adjust the model application area to an optional size while intentionally choosing the classification classes because it is unknown which piece of the training data has to be deleted to narrow the model application area to what extent. Therefore, there are cases where the model application area of the inspector model created by deleting the training data is not narrowed.

It can be said that the narrower the model application area for classification into a certain class in the feature space, the more vulnerable the certain class is to the concept drift. Therefore, in order to detect the accuracy deterioration of the machine learning model 10 targeted for monitoring, it is important to create a plurality of inspector models for which the model application areas are appropriately narrowed. Accordingly, when the model application area of the inspector model is not narrowed, it takes man-hours for recreation.

For example, it is difficult for the reference technique to properly create a plurality of inspector models for which the model application areas for the chosen classification classes are narrowed.

Thus, in the present embodiment, a detection model is created in which the decision boundary of the machine learning model in the feature space is widened to provide an unknown area in which the classification classes are undecided, and the model application area for each class is intentionally narrowed.

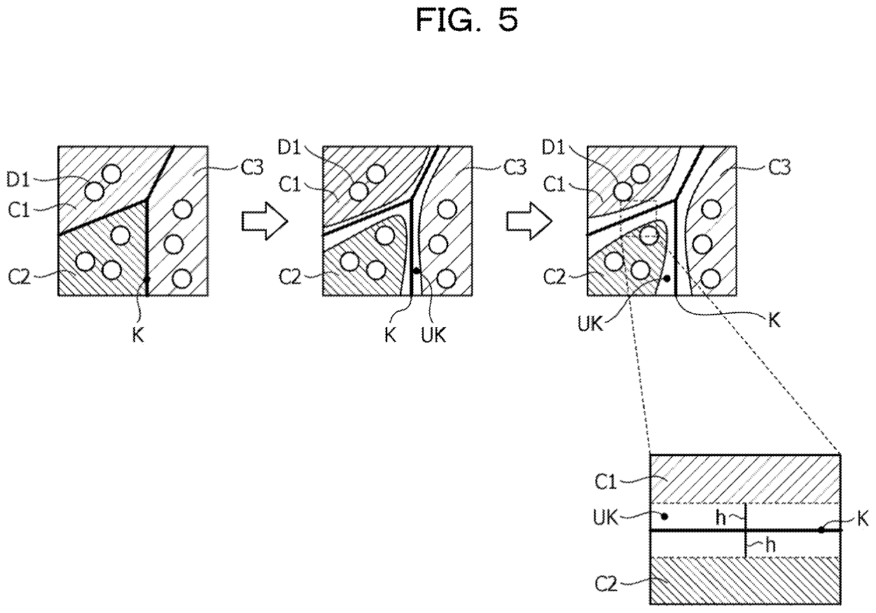

FIG. 5 is an explanatory diagram for explaining an outline of the detection model in the present embodiment. In FIG. 5, input data D1 indicates input data for a machine learning model targeted for detecting the accuracy change due to the concept drift. A model application area C1 is an area in the feature space in which the classification class is determined to be “A” by the machine learning model targeted for the detection. A model application area C2 is an area in the feature space in which the classification class is determined to be “B” by the machine learning model targeted for the detection. A model application area C3 is an area in the feature space in which the classification class is determined to be “C” by the machine learning model targeted for the detection. A decision boundary K is a boundary between the model application areas C1 to C3.

As illustrated on the left side of FIG. 5, the input data D1 is included in any one of the model application areas C1 to C3 with the decision boundary K as a delimiter and is therefore classified into any one of the classification classes “A” to “C” by using the machine learning model. In determination scores relating to the determination of the classification classes by the machine learning model, the decision boundary K is positioned where the score difference is zero between a classification class given the highest determination score value and a classification class having the next highest determination score value after the classification class given the highest determination score value. For example, when the machine learning model outputs the determination scores for each classification class, the decision boundary K is positioned where the score difference between a classification class having the highest determination score (first rank) and a classification class having the second highest determination score (second rank) is zero.

Thus, in the present embodiment, the determination scores relating to the determination of the classification classes when data is input to the machine learning model targeted for detecting the accuracy change due to the concept drift are calculated. Subsequently, a detection model is created in which, in terms of the calculated determination scores, when the score difference between a highest classification class (first-ranked classification class) and a next highest classification class (second-ranked classification class) after the highest classification class is equal to or less than a predetermined threshold value (parameter h), the classification class is undecided (treated as being unknown).

As illustrated in the center of FIG. 5, in the detection model created in this manner, an area of a predetermined width including the decision boundary K in the feature space is treated as an unknown area UK in which the classification classes are determined to be “unknown” indicating being undecided. For example, in the detection model, the model application areas C1 to C3 for each class are reliably narrowed by the unknown area UK. Since the model application areas C1 to C3 for each class are narrowed in this manner, the created detection model becomes a model more vulnerable to the concept drift than the machine learning model targeted for the detection. Accordingly, the accuracy deterioration of the machine learning model may be detected by the created detection model.

In addition, in the detection model, the score difference (parameter h) in the determination scores for the machine learning model only has to be specified, and no additional learning relating to the DNN is involved to create the detection model.

Furthermore, as illustrated on the right side of FIG. 5, by varying the magnitude of the parameter h, a plurality of detection models with different sizes of the unknown area UK (narrowness of the model application areas C1 to C3 for each class) is created. The created detection models become models more vulnerable to the concept drift as the unknown area UK is enlarged and the model application areas C1 to C3 for each class are narrowed. Accordingly, by creating a plurality of detection models having different vulnerabilities to the concept drift, the progress of accuracy deterioration in the machine learning model targeted for the detection may be worked out accurately.

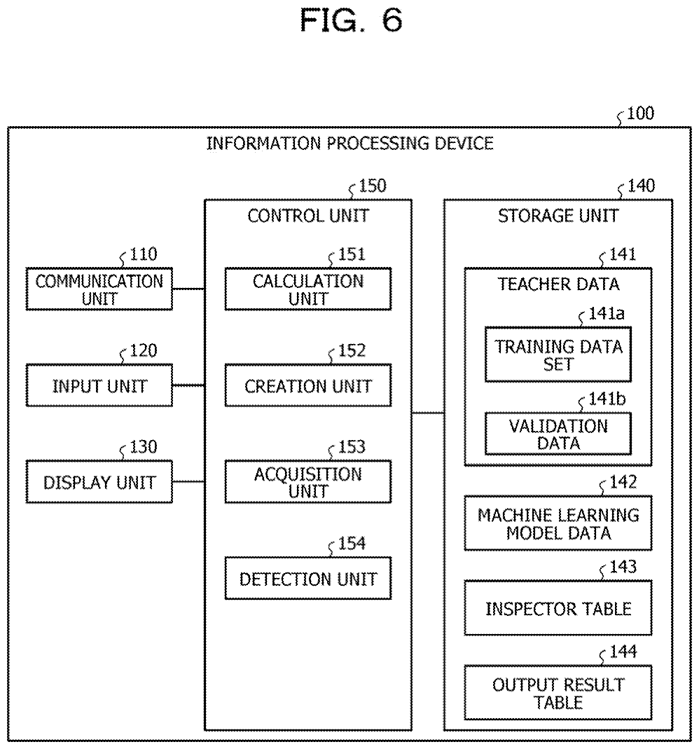

FIG. 6 is a block diagram illustrating a functional configuration example of an information processing device according to the present embodiment. As illustrated in FIG. 6, the information processing device 100 is a device that performs various processes relating to the creation of the detection model, and for example, a personal computer or the like can be applied.

For example, the information processing device 100 includes a communication unit 110, an input unit 120, a display unit 130, a storage unit 140, and a control unit 150.

The communication unit 110 is a processing unit that executes data communication with an external device (not illustrated) via a network. The communication unit 110 is an example of a communication device. The control unit 150 to be described later exchanges data with an external device via the communication unit 110.

The input unit 120 is an input device for inputting various types of information to the information processing device 100. The input unit 120 corresponds to a keyboard, a mouse, a touch panel, or the like.

The display unit 130 is a display device that displays information output from the control unit 150. The display unit 130 corresponds to a liquid crystal display, an organic electro luminescence (EL) display, a touch panel, or the like.

The storage unit 140 has teacher data 141, machine learning model data 142, an inspector table 143, and an output result table 144. The storage unit 140 corresponds to a semiconductor memory element such as a random access memory (RAM) or a flash memory (flash memory), or a storage device such as a hard disk drive (HDD).

The teacher data 141 has a training data set 141a and validation data 141b. The training data set 141a holds various types of information regarding the training data.

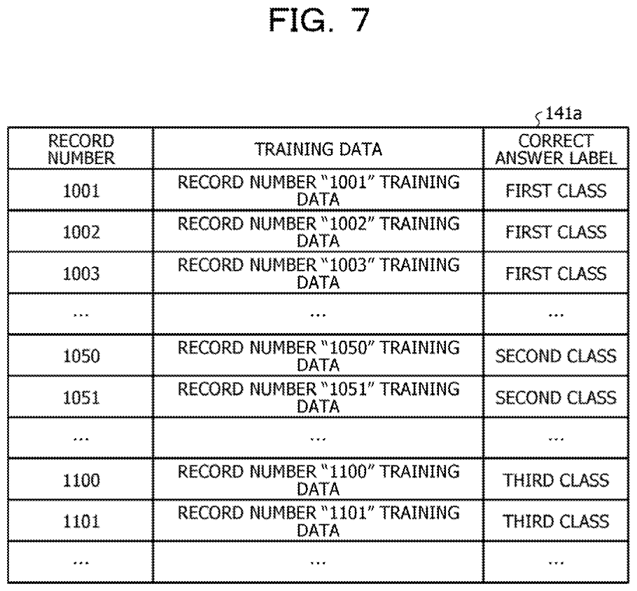

FIG. 7 is a diagram illustrating an example of the data structure of the training data set 141a. As illustrated in FIG. 7, the training data set 141a associates the record number, the training data, and the correct answer label with each other. The record number is a number that identifies the pair of the training data and the correct answer label. The training data corresponds to mail spam data, data for electricity demand forecast, stock price forecast, and poker hand, image data, and the like. The correct answer label is information that uniquely identifies one classification class among respective classification classes of a first class (A), a second class (B), and a third class (C).

The validation data 141b is data for validating the machine learning model that has learned with the training data set 141a. The validation data 141b is assigned with a correct answer label. For example, in a case where the validation data 141b is input to the machine learning model, when the output result output from the machine learning model matches the correct answer label assigned to the validation data 141b, it is meant that the machine learning model has properly learned with the training data set 141a.

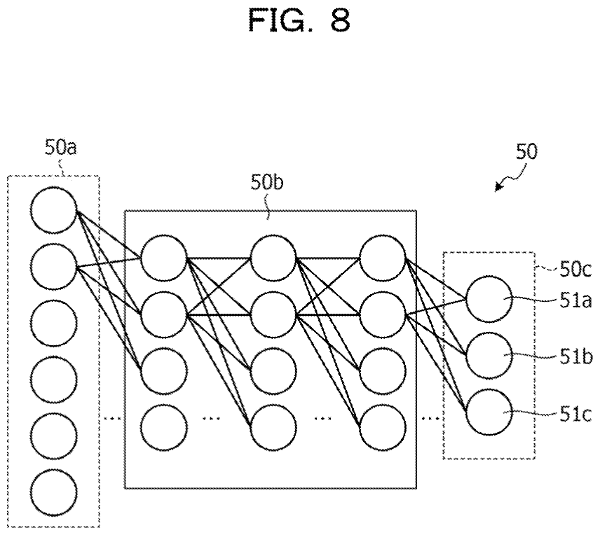

The machine learning model data 142 is data of the machine learning model targeted for detecting the accuracy change due to the concept drift. FIG. 8 is a diagram for explaining an example of the machine learning model. As illustrated in FIG. 8, a machine learning model 50 has a neural network structure and has an input layer 50a, a hidden layer 50b, and an output layer 50c. The input layer 50a, the hidden layer 50b, and the output layer 50c have a structure in which a plurality of nodes is connected by edges. The hidden layer 50b and the output layer 50c have a function called an activation function and bias values, and the edges have weights. In the following description, the bias values and weights will be referred to as “weight parameters”.

When data (the feature amount of data) is input to each node included in the input layer 50a, the probabilities for each class are output from nodes 51a, 51b, and 51c of the output layer 50c through the hidden layer 50b. For example, the probability of the first class (A) is output from the node 51a. The probability of the second class (B) is output from the node 51b. The probability of the third class (C) is output from the node 51c. The probability of each class is calculated by inputting the value output from each node of the output layer 50c to the Softmax function. In the present embodiment, the value before being input to the Softmax function is referred to as “score”, and this “score” is an example of the determination score.

For example, when training data corresponding to the correct answer label “first class (A)” is input to each node included in the input layer 50a, a value output from the node 51a, which is a value before being input to the Softmax function, is assumed as the score of the input training data. When training data corresponding to the correct answer label “second class (B)” is input to each node included in the input layer 50a, a value output from the node 51b, which is a value before being input to the Softmax function, is assumed as the score of the input training data. When training data corresponding to the correct answer label “third class (C)” is input to each node included in the input layer 50a, a value output from the node 51c, which is a value before being input to the Softmax function, is assumed as the score of the input training data.

The machine learning model 50 is assumed to have finished learning on the basis of the training data set 141a and the validation data 141b of the teacher data 141. In the learning of the machine learning model 50, when each piece of the training data of the training data set 141a is input to the input layer 50a, parameters of the machine learning model 50 are learned (learned by the error back propagation method) such that the output result of each node of the output layer 50c approaches the correct answer label of the input training data.

The description returns to FIG. 6. The inspector table 143 is a table that holds data of a plurality of detection models (inspector models) that detect the accuracy deterioration of the machine learning model 50.

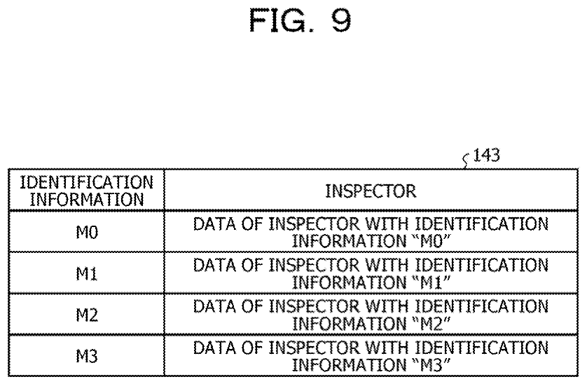

FIG. 9 is a diagram illustrating an example of the data structure of the inspector table 143. As illustrated in FIG. 9, the inspector table 143 associates identification information (for example, M0 to M3) with the inspector models. The identification information is information that identifies the inspector models. The inspector contains the data of the inspector model corresponding to the model identification information. The data of the inspector model includes, for example, the parameter h described in FIG. 5.

The description returns to FIG. 6. The output result table 144 is a table in which the output result of each inspector model when the data of the system during operation is input to each inspector model (detection model) according to the inspector table 143 is registered.

The control unit 150 includes a calculation unit 151, a creation unit 152, an acquisition unit 153, and a detection unit 154. The control unit 150 may be implemented by a central processing unit (CPU), a micro processing unit (MPU), or the like. Furthermore, the control unit 150 may also be implemented by a hard wired logic such as an application specific integrated circuit (ASIC) or a field programmable gate array (FPGA).

The calculation unit 151 acquires the machine learning model 50 from the machine learning model data 142. Additionally, the calculation unit 151 is a processing unit that calculates the determination scores relating to the determination of the classification classes when data is input to the acquired machine learning model 50. For example, by inputting data to the input layer 50a of the machine learning model 50 constructed with the machine learning model data 142, the calculation unit 151 obtains the determination score such as the probability of each class from the output layer 50c.

Note that, when the machine learning model 50 does not output the determination score from the output layer 50c (directly outputs the classification result), a machine learning model that has learned using the teacher data 141 used for learning of the machine learning model 50 so as to output the determination score such as the probability of each class may also be substituted. For example, by inputting data to the machine learning model that has learned on the basis of the teacher data 141 used for learning of the machine learning model 50 so as to output the determination score, the calculation unit 151 acquires the determination score relating to the determination of the classification class when data is input to the machine learning model 50.

Based on the calculated determination scores, the creation unit 152 calculates the difference in the determination scores between a first classification class that has a highest value of the calculated determination scores and a second classification class whose value of the calculated determination scores has a next highest value after the first classification class. Then, the creation unit 152 is a processing unit that creates a detection model that determines the classification classes to be undecided when the difference in the determination scores between the first classification class that has the highest value of the determination scores and the second classification class whose value of the determination scores has the next highest value after the first classification class is equal to or less than a predetermined threshold value. For example, the creation unit 152 designates a plurality of parameters h to narrow the model application areas C1 to C3 (details will be described later) and registers each of the designated parameters h in the inspector table 143.

The acquisition unit 153 is a processing unit that inputs operation data of the system whose feature amount changes with the passage of time to each of a plurality of inspector models and acquires the output results.

For example, the acquisition unit 153 acquires the data (parameters h) of the inspector models whose identification information is M0 to M2 from the inspector table 143 and executes each inspector model with respect to the operation data. For example, the acquisition unit 153 treats the classification class as being undecided (unknown) when, in terms of the values of the determination scores obtained by inputting the operation data to the machine learning model 50, the score difference between a highest classification class (first-ranked classification class) and a next highest classification class (second-ranked classification class) after the highest classification class is equal to or less than the parameter h. Note that, when the score difference is not equal to or less than the parameter h, the classification class is according to the determination score. Subsequently, the acquisition unit 153 registers the output results obtained by executing each inspector model with respect to the operation data, in the output result table 144.

The detection unit 154 is a processing unit that detects the accuracy change in the machine learning model 50 based on the time change in the operation data, on the basis of the output result table 144. For example, the detection unit 154 acquires a degree of agreement between outputs from each inspector model with respect to an instance and detects the accuracy change in the machine learning model 50 from the tendency of the acquired degree of agreement. For example, when the degree of agreement between outputs from each inspector model is significantly low, it is assumed that the accuracy deterioration due to the concept drift has occurred. The detection unit 154 outputs the detection result relating to the accuracy change in the machine learning model 50 from the display unit 130. This allows a user to recognize the accuracy deterioration due to the concept drift.

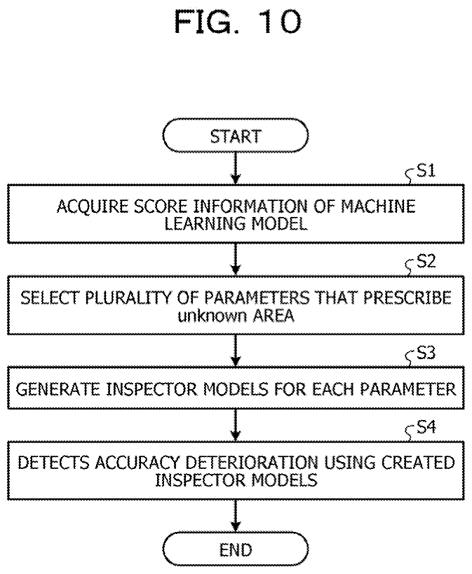

Here, the details of the processing of the calculation unit 151, the creation unit 152, the acquisition unit 153, and the detection unit 154 will be described. FIG. 10 is a flowchart illustrating a working example of the information processing device 100 according to the present embodiment.

As illustrated in FIG. 10, once the processing is started, the calculation unit 151 constructs the machine learning model 50 targeted for the detection with the machine learning model data 142. Subsequently, the calculation unit 151 inputs the teacher data 141 used at the time of learning of the machine learning model 50 to the input layer 50a of the constructed machine learning model 50. This causes the calculation unit 151 to acquire score information on the determination scores such as the probability of each class from the output layer 50c (S1).

Subsequently, the creation unit 152 executes a process of selecting a plurality of parameters h relating to the detection models (inspector models), which prescribe the unknown area UK, on the basis of the acquired score information (S2). Note that the parameters h are allowed to have any values as long as the values are different from each other and selected, for example, so as to be at equal intervals according to the percentage of the teacher data 141 contained in the unknown area UK in the feature space (for example, 20%, 40%, 60%, 80%, and so on).

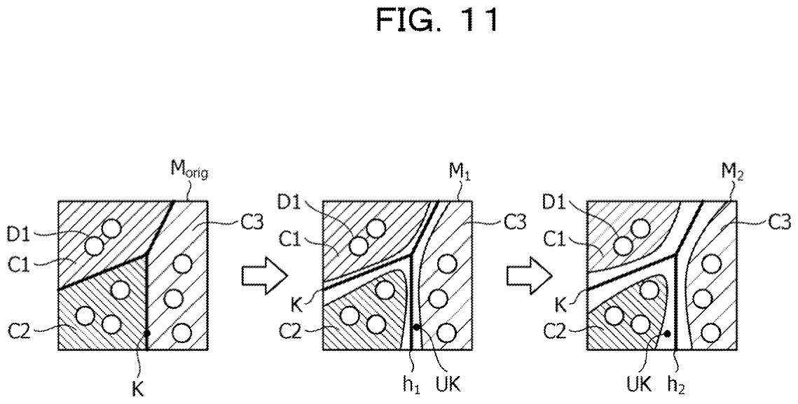

FIG. 11 is an explanatory diagram illustrating an outline of a process of selecting the parameters h. In FIG. 11, M_{orig} indicates the machine learning model 50 (original model). In addition, M₁, M₂, . . . indicate the detection models (inspector models) for which the model application areas C1 to C3 are narrowed. Note that the subscript numbers of M have i=1, . . . , n, and n denotes the number of detection models.

As illustrated in FIG. 11, the creation unit 152 selects n kinds of h (h≥0) of the parameters h relating to M₁, M₂, . . . , Mᵢ in S2.

Here, the input data D1 will be simply referred to as “D” unless otherwise distinguished, the training data set 141a (test data) included in the teacher data 141 will be referred to as Dₜₑₛₜ, and the operation data will be referred to as D_{drift}.

In addition, agreement(Mₐ, M_{b}, D) is defined as a function to compute the degree of agreement between the models. This agreement function returns the ratio of the quantity of determination matches between two models (Mₐ and M_{b}) with respect to an instance of D. However, in the agreement function, undecided classification classes are not considered to match with each other.

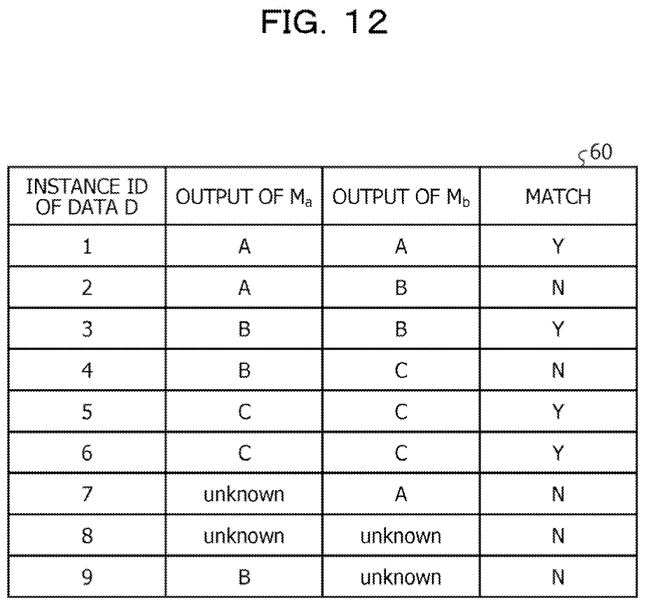

FIG. 12 is an explanatory diagram illustrating an example of class classification of each model with respect to instances. As illustrated in FIG. 12, a class classification result 60 indicates outputs (classification) from the models Mₐ and M_{b} with respect to instances (1 to 9) of the data D and the presence/absence (Y/N) of a match. In such a class classification result 60, the agreement function returns the value as follows.

Agreement Function (Mₐ, M_{b}, D)=Number of Matches/Number of Instances=4/9

In addition, agreement2(h, D)=agreement(M_{orig}, Mₕ, D) is defined as an auxiliary function. Mₕ denotes a model obtained by narrowing the model M_{orig} using the parameter h.

The creation unit 152 designates hᵢ (i=1, . . . , n) of the parameters h as follows such that the degree of agreement with respect to Dₜₑₛₜ is arithmetically decreased (for example, 20%, 40%, 60%, 80%, and so on). Note that agreement2(h, D) gives a monotonous decrease with respect to h.

hᵢ=argmaxₕ agreement2(h,Dₜₑₛₜ) s.t. agreement2(h,Dₜₑₛₜ)≤(n−i)/n

Returning to FIG. 10, the creation unit 152 generates inspector models (detection models) for each selected parameter (hᵢ) (S3). For example, the creation unit 152 registers each of the designated values of hᵢ in the inspector table 143.

These inspector models (detection models) internally refer to the original model (machine learning model 50). Then, the inspector models (detection models) behave so as to replace the determination result with being undecided (unknown) if the output of the original model is in the unknown area UK based on hᵢ registered in the inspector table 143.

For example, the acquisition unit 153 inputs the operation data (D_{drift}) to the machine learning model 50 to obtain the determination scores. Subsequently, in terms of the obtained determination scores, when the score difference between the first-ranked classification class and the second-ranked classification class is equal to or less than hᵢ registered in the inspector table 143, the acquisition unit 153 treats the classification class as being undecided (unknown). Note that, when the score difference is not equal to or less than the parameter h, the classification class is according to the determination score. The acquisition unit 153 registers the output results obtained by executing each inspector model, in the output result table 144. The detection unit 154 detects the accuracy change in the machine learning model 50 on the basis of the output result table 144.

In this manner, the information processing device 100 detects the accuracy deterioration using the inspector models created by the creation unit 152 (S4).

For example, the acquisition unit 153 determines whether or not the classification class is to be treated as being undecided (unknown), using sureness(x), which is a function for the score difference between the top two classification classes.

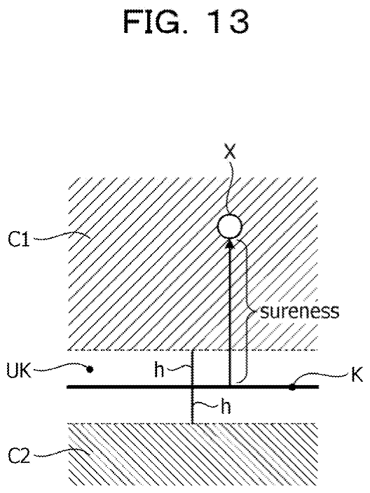

FIG. 13 is an explanatory diagram for explaining the sureness function. As illustrated in FIG. 13, it is assumed that an instance_{X} is determined using the inspector models with the parameters h.

Here, the score of a classification class having the highest score when the inspector models determine the instance_{X} is denoted by s_{first}, and the score of a classification class having the second score is denoted by s_{second}.

The sureness function is as follows. Note that φ(s) is assumed as log(s) if the model scores range from zero or more to one or less, and is assumed as s otherwise.

sureness(x):=φ(s_{first})−φ(s_{second})

In the present embodiment, since the areas are ordered using the difference in scores (sureness), the arithmetic operations of the difference in scores are meaningful. In addition, the difference in scores is supposed to be of equal worth regardless of the areas.

For example, a score difference at a certain point (4−3=1) is supposed to be equal in worth to a score difference at another point (10−9=1). In order to satisfy such a property, for example, the difference in scores only has to correspond to a loss function. Since the loss function takes the average as a whole, the loss function is additive, and the worth of the same values is equal everywhere.

For example, when the model uses log-loss as the loss function, the loss is expressed as −yᵢ log(pᵢ) with yᵢ as the true value and pᵢ as the predicted correct answer probability. Since log(pᵢ) is additive here, it is suitable to use log(pᵢ) as a score.

However, since many machine learning (ML) algorithms output pᵢ as a score, log( ) is supposed to be applied in that case.

If it is known that the score means the probability, log( ) only has to be applied. When it is unclear, there is an option to make an automatic determination (for example, to apply if ranging from zero or more to one or less), or there is another option to conservatively use the score value as it is without applying anything.

As indicated below, the reason why the function φ is inserted in the definition of the function sureness is that the score is converted by φ so as to satisfy the above property.

sureness(x):=φ(score_{first})−φ(score_{second})

Here, the acquisition unit 153 alters the determination result for the narrowed model Mᵢ from the determination result for M_{orig} as follows.

When sureness(x)≥hᵢ is met: the class determined by M_{orig} is used as it is.

When sureness(x)<hᵢ is met: the unknown class is adopted.

In addition, the detection unit 154 detects the deterioration of model accuracy using a function (ag_mean(D)) for computing a mean degree of agreement for the data D among the respective inspector models. This ag_mean(D) is as follows.

ag_mean(D):=meanᵢ(agreement(M_{orig},Mᵢ,D))

Then, the detection unit 154 works out agreement(M_{orig}, Mᵢ, D_{drift}) for each Mᵢ and determines, from the tendency of the worked-out agreement(M_{orig}, Mᵢ, D_{drift}), whether or not there is accuracy deterioration. For example, if ag_mean(D_{drift}) is significantly smaller than ag_mean(Dₜₑₛₜ), it is determined that there is accuracy deterioration due to the concept drift.

Here, a high-speed computation of the mean degree of agreement ag_mean(D_{drift}) in the computation process performed by the detection unit 154 will be described.

When the computation is conducted straight in accordance with the above definition, the computation time increases as the number n of the narrowed models grows. However, a trade-off that the detection accuracy degrades when n is made smaller occurs. By using the computation method described below, however, the detection unit 154 may conduct high-speed computation nearly without being affected by the number n of the models.

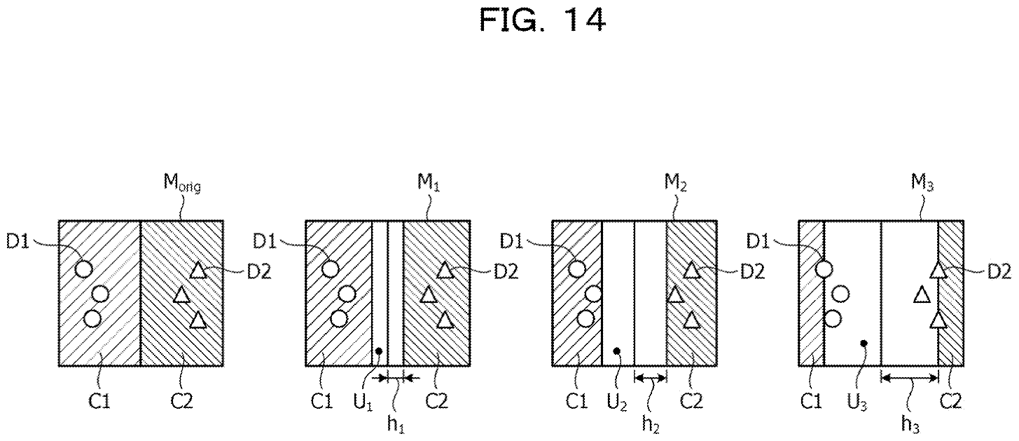

Here, the unknown area defined by hᵢ is assumed as U. FIG. 14 is an explanatory diagram explaining a relationship between the unknown area and the parameters.

As illustrated in FIG. 14, when the aforementioned definition of hᵢ is used, if i<j is met, the relationship of hᵢ≤hⱼ and Uᵢ⊂Uⱼ is established. This means that a total order relationship is established between the respective unknown areas Uᵢ, and additionally, the order of Uᵢ keeps the order of hᵢ. In the illustrated example, it can be said that h₁<h₂<h₃ [symbol] U₁⊂U₂⊂U₃.

Accordingly, for the computation of a certain area, the computation result for a smaller area contained in the certain area can be utilized. In addition, for the relationship between the areas Uᵢ, it is sufficient to see only the relationship of hᵢ. In this computation method, these properties are utilized.

First, definitions are made as follows.
The unknown area defined by hᵢ is denoted by Uᵢ. This means that Uᵢ:={x|sureness(x)<hᵢ} is met.
The ratio of D_{drift} falling within Uᵢ is denoted by uᵢ. uᵢ:=|{x|x∈Uᵢ, x∈D_{drift}}|/|D_{drift}|
From the definition of the agreement2 function, the following is established. agreement2(hᵢ, D_{drift})=1−uᵢ
A difference area Rᵢ is defined as Rᵢ:=Uᵢ−Uᵢ₋₁. However, R₁:=U₁ is met.
When i≥2 is met, Rᵢ={x|hᵢ₋₁≤sureness(x)<hᵢ} is met.
The rate of D_{drift} falling within Rᵢ is denoted by rᵢ. rᵢ:=|{x|x∈Rᵢ, x∈D_{drift}}|/|D_{drift}|
When r₁=u₁ and i≥2 are met, rᵢ=uᵢ−uᵢ₋₁ is met.
In addition, uᵢ=rᵢ+rᵢ₋₁+ . . . +r₂+r₁ is met.
Next, the high-speed computation of ag_mean(Dₜₑₛₜ) and ag_mean(D_{drift}) is as follows.

$$ag\_mean ( {D}_{t e s t} ) = m e a {n}_{i = 1 … n} ( a g r e e m e n t 2 ( {h}_{i} , {D}_{t e s t} ) ) = mea {n}_{i = 1 … n} ( ( n - i ) / n ) = 1 / 2 ( 1 - 1 / n ) \\ ag\_mean ( {D}_{drift} ) = m e a {n}_{i = 1 … n} ( a g r e e m e n t 2 ( {h}_{i} , {D}_{drift} ) ) = mea {n}_{i = 1 … n} ( 1 - {u}_{i} ) = mea {n}_{i = 1 … n} ( 1 - ( {r}_{1} + {r}_{2} + … + {r}_{i} ) ) = mea {n}_{i = 1 … n} ( {r}_{i + 1} + {r}_{i + 2} + … + {r}_{n} ) = 1 / {n}^{*} ( {r}_{2} + {r}_{3} + … + {r}_{n} + {r}_{3} + … + {r}_{n} … + {r}_{n} ) = mea {n}_{i = 1 … n} ( {( i - 1 )}^{*} {r}_{i} ) ; \\ {r}_{i} is expanded in accordance with the definition = {mean}_{x ∈ Ddrift} ( s u 2 i n d e x ( s u r e n e s s ( x ) ) - 1 ) / \vert {D}_{drift} \vert$$

Note that su2index( ) is a function that takes sureness(x) as an argument and returns the subscript of the area Rᵢ to which x belongs. This function can be achieved by a binary search or the like by using the relationship of Rᵢ={x|hᵢ₋₁≤sureness(x)<hᵢ} when i≥2 is met.

The term su2index ( ) corresponds to the quantile, which is a robust statistic. The amount of computation is as follows.
Amount of Computation: O(d log(min(d, t, n))), where t=|Dₜₑₛₜ|, d=|D_{drift}|

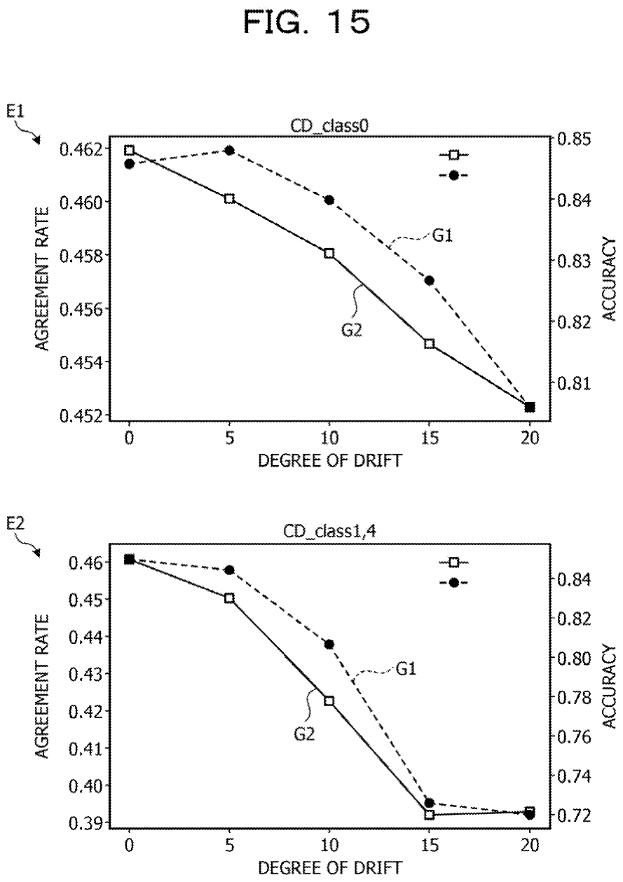

FIG. 15 is an explanatory diagram explaining validation results. A validation result E1 in FIG. 15 is a validation result relating to a classification class 0, and a validation result E2 is a validation result relating to classification classes 1 and 4. Note that the graph G1 is a graph indicating the accuracy of the original model (machine learning model 50), and the graph G2 is a graph indicating the agreement rate of a plurality of inspector models. In the validation, for example, the teacher data 141 was adopted as the original data, and data in which the scale of alteration (the degree of drift) of the original data was strengthened by rotation or the like was validated as the input data.

As is clear from the comparison between the graph G1 and the graph G2 in FIG. 15, the graph G2 of the inspector models also falls according to the deterioration of the accuracy of the model (fall in the graph G1). Accordingly, the accuracy deterioration due to the concept drift may be detected from the fall of the graph G2. In addition, since the correlation between the fall of the graph G1 and the fall of the graph G2 is strong, the accuracy of the machine learning model 50 targeted for the detection may be worked out on the basis of the level of fall of the graph G2.

(Modifications)

In the above embodiment, the quantity (n) of detection models (inspector models) is prescribed. In addition, an insufficient quantity causes a disadvantage that the accuracy of deterioration detection degrades. Thus, in a modification, a method is provided in which the quantity of detection models (inspector models) does not have to be prescribed. Theoretically, the quantity of detection models (inspector models) is assumed as infinite. Note that the computation time in this case is almost the same as in the case of prescribing the quantity.

For example, the creation unit 152 only has to examine the probability distribution (cumulative distribution function) of above-described sureness, based on the calculated determination scores. By examining the probability distribution of sureness in this manner, the detection models (inspector models) can be theoretically deemed as if there were an infinite number of detection models (inspector models) and additionally, are no longer supposed to be created explicitly.

In addition, in the acquisition unit 153, when the mean agreement rate is computed in the mechanism of detecting the deterioration of model accuracy, the computation is conducted as follows.
In the high-speed computation of ag_mean(Dₜₑₛₜ) and ag_mean(D_{drift}), the quantity n of inspector models is set to infinity (n to co).
ag_mean(Dₜₑₛₜ)=1/2
ag_mean(D_{drift})=mean_{x∈Ddrift}(Su2pos(sureness(X)))
In Dₜₑₛₜ, the cumulative distribution function F(s)=P(Xs≤s) of a variable s defined by {s|s=sureness(x), x∈Dₜₑₛₜ} is worked out, and the function su2pos is defined as below.
su2pos(sureness):=F(sureness)

This su2pos( ) also corresponds to the quantile, which is a robust statistic. Consequently, the amount of computation is as follows.
Amount of Computation: O(d log(min(d, t)), where t=|Dₜₑₛₜ|, d=|D_{drift}|

As described above, the information processing device 100 includes the calculation unit 151 and the creation unit 152. The calculation unit 151 acquires the machine learning model 50 targeted for detecting the accuracy change and calculates the determination scores relating to the determination of the classification classes when data is input to the acquired machine learning model 50. The creation unit 152 calculates the difference in the determination scores between a first classification class that has a highest value of the calculated determination scores and a second classification class whose value of the calculated determination scores has a next highest value after the first classification class. In addition, the creation unit 152 creates a detection model that determines the classification classes to be undecided when the difference between the calculated determination scores is equal to or less than a preset threshold value.

In this manner, since a detection model is created in which the decision boundary of the machine learning model 50 in the feature space is widened to provide the unknown area UK in which the classification classes are undecided, and the model application areas C1 to C3 for each class are intentionally narrowed, the information processing device 100 may detect the accuracy deterioration of the machine learning model 50 with the created detection model.

In addition, the creation unit 152 creates a plurality of detection models having threshold values different from each other. In this manner, the information processing device 100 creates a plurality of detection models having threshold values different from each other, which is a plurality of detection models having different sizes of the unknown area UK. This allows the information processing device 100 to detect the progress of the accuracy deterioration of the machine learning model 50 due to the concept drift with the created plurality of detection models.

Furthermore, the creation unit 152 specifies the threshold values such that the matching ratio between the determination results for the classification classes by the machine learning model 50 in each determination score and the determination results for the classification classes by the detection models in each determination score is adopted as a predetermined value. This allows the information processing device 100 to create a detection model in which the matching ratio has a predetermined ratio with respect to the determination result of the machine learning model 50 with respect to the input data, and therefore, the degree of deterioration in accuracy of the machine learning model 50 due to the concept drift may be measured with the created detection model.

In addition, the calculation unit 151 calculates the determination score using the teacher data 141 relating to learning of the machine learning model 50. In this manner, in the information processing device 100, the detection model may also be created on the basis of the determination score calculated with the teacher data 141 relating to learning of the machine learning model 50, as a sample. By using the teacher data 141 in this manner, the information processing device 100 may easily create the detection model without preparing new data for creating the detection model.

Pieces of information including the processing procedure, the control procedure, the specific name, various types of data and parameters indicated in the above embodiments may be optionally adapted. Furthermore, the specific examples, distributions, numerical values, and the like described in the above embodiments are merely examples and may be adapted in any ways.

In addition, each constituent element of each device illustrated in the drawings is functionally conceptual and does not necessarily have to be physically configured as illustrated in the drawings. For example, specific forms of distribution and integration of individual devices are not limited to those illustrated in the drawings. For example, all or a part of the devices may be configured by being functionally or physically distributed or integrated in optional units depending on various loads, usage situations, or the like. Moreover, all or any part of individual processing functions performed by each device may be implemented by a central processing unit (CPU) and a program analyzed and executed by the corresponding CPU, or may be implemented as hardware by wired logic.

For example, various processing functions performed by the information processing device 100 may also be entirely or optionally partially executed on a CPU (or a microcomputer such as a microprocessor unit (MPU) or a micro controller unit (MCU)). In addition, it is needless to say that all or any part of the various processing functions may also be executed on a program analyzed and executed by a CPU (or a microcomputer such as an MPU or an MCU) or in hardware by wired logic. Furthermore, various processing functions performed by the information processing device 100 may also be executed by a plurality of computers in cooperation through cloud computing.

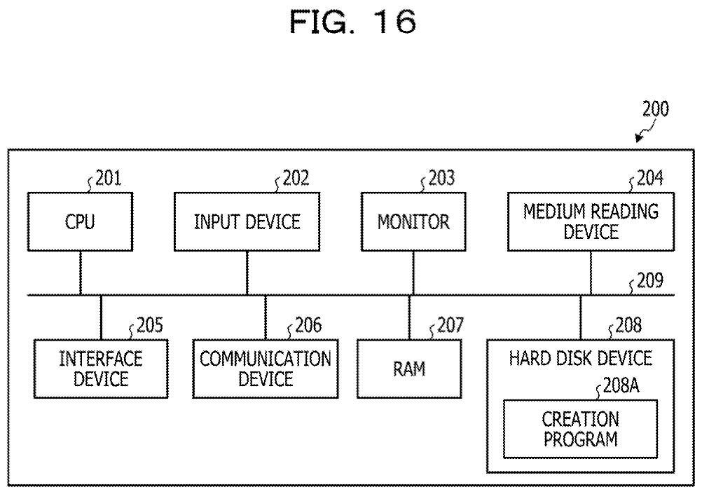

Meanwhile, the various types of processing described in the above embodiments may be implemented by executing a program prepared in advance on a computer. Thus, in the following, an example of a computer that executes a program having functions similar to the functions of the above embodiments will be described. FIG. 16 is a block diagram illustrating an example of a computer that executes a creation program.

As illustrated in FIG. 16, a computer 200 includes a CPU 201 that executes various types of arithmetic processing, an input device 202 that receives data input, and a monitor 203. In addition, the computer 200 includes a medium reading device 204 that reads a program and the like from a storage medium, an interface device 205 for connecting to various devices, and a communication device 206 for connecting to other information processing devices and the like by wire or wirelessly. Furthermore, the computer 200 also includes a RAM 207 that temporarily stores various types of information, and a hard disk device 208. Besides, each of the devices 201 to 208 is connected to a bus 209.

The hard disk device 208 stores a creation program 208A for implementing functions similar to the functions of the respective processing units illustrated in FIG. 6, namely, the calculation unit 151, the creation unit 152, the acquisition unit 153, and the detection unit 154. In addition, the hard disk device 208 stores various types of data (for example, inspector table 143 and the like) related to the calculation unit 151, the creation unit 152, the acquisition unit 153, and the detection unit 154. For example, the input device 202 receives inputs of various types of information such as operation information from a user of the computer 200. For example, the monitor 203 displays various screens such as a display screen to the user of the computer 200. For example, a printing device and the like are connected to the interface device 205. The communication device 206 is connected to a network (not illustrated) and exchanges various types of information with other information processing devices.

By reading the creation program 208A stored in the hard disk device 208 and loading the read creation program 208A into the RAM 207 to execute the loaded creation program 208A, the CPU 201 causes a process that executes each function of the information processing device 100 to work. For example, this process executes a function similar to the function of each processing unit included in the information processing device 100. For example, the CPU 201 reads the creation program 208A for implementing functions similar to the functions of the calculation unit 151, the creation unit 152, the acquisition unit 153, and the detection unit 154 from the hard disk device 208. Then, the CPU 201 executes a process that executes processing similar to the processing of the calculation unit 151, the creation unit 152, the acquisition unit 153, and the detection unit 154.

Note that the above-mentioned creation program 208A does not have to be stored in the hard disk device 208. For example, the creation program 208A stored in a storage medium that is readable by the computer 200 may also be read and executed by the computer 200. For example, the storage medium that is readable by the computer 200 corresponds to a portable recording medium such as a compact disk read only memory (CD-ROM), a digital versatile disc (DVD), or a universal serial bus (USB) memory, a semiconductor memory such as a flash memory, a hard disk drive, or the like. Furthermore, the creation program 208A may also be prestored in a device connected to a public line, the Internet, a local area network (LAN), or the like such that the computer 200 reads the creation program 208A from this device to execute the creation program 208A.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A creation method that is executed by a computer, the creation method comprising:
acquiring scores representing accuracy of classification of a machine learning model that classifies input data into classes;
acquiring a difference in the scores between a first class that has a highest score and a second class that has a next highest score after the first class; and
generating a first detection model that determines the classification is undecided when the difference is equal to or less than a first threshold value.

2. The creation method according to claim 1, wherein
the generating includes generating a second detection model that has a second threshold value different from the first threshold value.

3. The creation method according to claim 1, wherein
the generating includes specifying the first threshold values so that a matching ratio between the classification by the machine learning model and the classification by the first detection model in each of the scores is adopted as a certain value.

4. The creation method according to claim 1, wherein
the acquiring the scores includes acquiring the scores by using teacher data related to learning of the machine learning model.

5. A non-transitory computer-readable storage medium storing a creation program that causes at least one computer to execute a process, the process comprising:
acquiring scores representing accuracy of classification of a machine learning model that classifies input data into classes;
acquiring a difference in the scores between a first class that has a highest score and a second class that has a next highest score after the first class; and
generating a first detection model that determines the classification is undecided when the difference is equal to or less than a first threshold value.

6. The non-transitory computer-readable storage medium according to claim 5, wherein
the generating includes generating a second detection model that has a second threshold value different from the first threshold value.

7. The non-transitory computer-readable storage medium according to claim 5, wherein
the generating includes specifying the first threshold values so that a matching ratio between the classification by the machine learning model and the classification by the first detection model in each of the scores is adopted as a certain value.

8. The non-transitory computer-readable storage medium according to claim 5, wherein
the acquiring the scores includes acquiring the scores by using teacher data related to learning of the machine learning model.

9. An information processing device comprising:
one or more memories; and
one or more processors coupled to the one or more memories and the one or more processors configured to:
acquire scores representing accuracy of classification of a machine learning model that classifies input data into classes,
acquire a difference in the scores between a first class that has a highest score and a second class that has a next highest score after the first class, and
generate a first detection model that determines the classification is undecided when the difference is equal to or less than a first threshold value.

10. The information processing device according to claim 9, wherein the one or more processors are further configured to
generate a second detection model that has a second threshold value different from the first threshold value.

11. The information processing device according to claim 9, wherein the one or more processors are further configured to
specify the first threshold values so that a matching ratio between the classification by the machine learning model and the classification by the first detection model in each of the scores is adopted as a certain value.

12. The information processing device according to claim 9, wherein the one or more processors are further configured to
acquire the scores by using teacher data related to learning of the machine learning model.
